(19) United States
(12) Patent Application Publication
(10) Pub. No.: US 2013/0002608 A1
(43) Pub. Date: Jan. 3, 2013

(54) HUMAN-MACHINE INTERFACE

(75) Inventor: Frederic Autran, Paris (FR)

(73) Assignee: VALEO SYSTEMES THERMIQUES, Le Mesnil-Saint-Denis (FR)

(21) Appl. No.: 13/634,273

(22) PCT Filed: Mar. 30, 2011
(86) PCT No.: PCT/FR2011/000188

§ 371 Date: Sep. 12, 2012

(30) Foreign Application Priority Data
Mar. 31, 2010 (FR) 1001317

(51) Int. Cl. G06F 3/044

(52) U.S. Cl. 345/174

(57) ABSTRACT

The invention relates to a human-machine interface comprising a tactile detection means 1 and a holder 2 intended to be mounted in a casing 3, said holder comprises an upper face 4 oriented towards a user of the human-machine interface and a lower face 5 opposite the upper face 4, said holder 2 also comprises an opening 6, characterized in that the tactile detection means 1 is fixed to said holder 2. Application to motor vehicles.

The technical field of the present invention is that of touch-sensitive detection devices that are on board a human-machine interface. These touch-sensitive detection devices are used today in many fields such as home automation, computer hardware and in general for all systems for controlling an item of equipment. The subject of the invention is more particularly the application of such devices to the motor vehicle. In this field, these devices are commonly called human-machine interfaces as being a display and control device for items of vehicle equipment. This type of human-machine interface is found in the interior of the vehicle for controlling the navigation system, the audio or multimedia system or the air conditioning system.

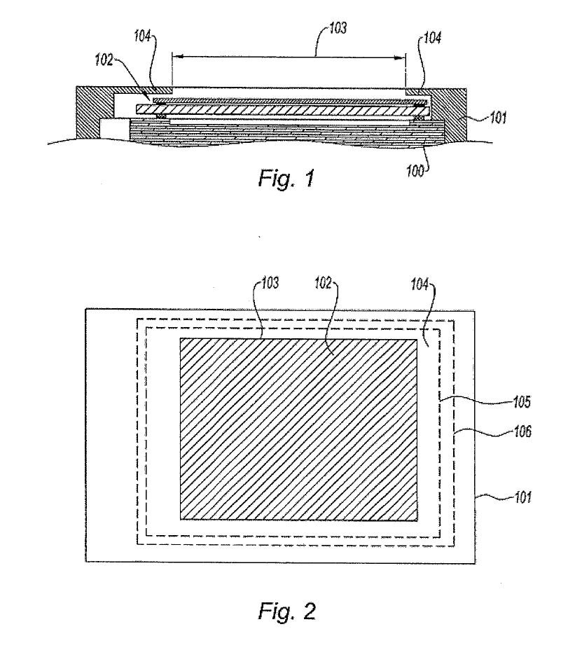

FIGS. 1 and 2 show a device according to the prior art. A screen 100 is installed in a housing 101, the latter having an opening 103. The screen 100 has an upper face on which a sensor 102 is placed in line with the opening 103. The opening 103 is bordered by a surround 104 of the housing 101, said surround 104 overlapping the sensor 102. FIG. 2 shows the outer edge 105 of the sensor 102 and also the outer edge 106 of the display device 100 and it can be seen that the surround 104 of the housing considerably covers the effective surface of the sensor 102.

Such an arrangement has many drawbacks. One of the main drawbacks is that the surround 104 forms an extra thickness relative to the upper portion of the sensor 102, which spoils the general appearance of the device. Specifically, for esthetic reasons, it is increasingly desirable that the overall surface of the HMI that can be seen by the user be as smooth and uniform as possible and it is clearly understood that such an extra thickness between the sensor and the housing goes against this smooth and uniform property. This is the consequence of using materials with different expansion properties. Specifically, the sensor 102 consists mainly of glass while the housing is usually made of plastic. Since the coefficients of expansion are different, it is not possible to maintain a constant clearance in all circumstances. This is why the devices of the prior art propose an overlap between the sensor and the surround while leaving an operating clearance which creates the drawbacks mentioned above.

Another drawback of the devices of the prior art lies in the fact that the style effects of the surround bordering the touch-sensitive sensor are not possible because the surround cannot extend too much over the sensor. This is therefore a technical obstacle which prevents said style effects.

The object of the present invention is therefore to solve at least one of the drawbacks described above mainly by reversing the method of attachment of a touch-sensitive detection means, that is to say by separating it from the screen with which it usually interacts. The invention uses a support to which the touch-sensitive detection means is attached in a suspended manner. As the coefficients of expansion of the materials of the touch-sensitive detection means and of the support are similar, there is little or no movement of one relative to the other and the clearance to be observed is transferred to another location of the device where it becomes easier to manage.

Moreover, the support offers the possibility of masking the peripheral imperfections of the touch-sensitive detection means while serving as a flat reference surface for the installation of the decorative portion.

The subject of the invention is therefore a human-machine interface comprising a touch-sensitive detection means and a support designed to be mounted in a housing, said support comprises an upper face oriented toward a user of the human-machine interface and a lower face opposite to the upper face, said support also comprises an opening, which is innovative in that the touch-sensitive detection means is attached to the lower face of said support, advantageously by bonding.

According to a second feature of the invention, the opening is delimited by an edge of the support, the touch-sensitive detection means being attached to said edge.

According to another feature of the invention, the support is a flat and rigid element, in particular a metal plate with a thickness of less than 0.5 mm.

According to another feature of the invention, the edge is peripheral all around the opening.

Advantageously, a film is placed on the upper face of the support so as to cover the opening and the edge.

The film is a film with decorative properties and/or a film with antiscratch properties and/or a film with antireflective properties and/or a film with diffusion properties and/or a film with polarizing properties.

According to another feature of the invention, a filling element is placed between the touch-sensitive detection means and the film, said filling element being installed in line with the opening.

The filling element is a transparent film.

Advantageously, a masking layer is interposed between the upper face of the support and said film.

According to another feature of the invention, the film also covers the housing, in particular its sharp edge.

The touch-sensitive detection means is a resistive or capacitive sensor, said sensor comprises a main plate and a secondary plate, said touch-sensitive detection means being attached to the lower face of the support by said secondary plate.

Alternatively, the touch-sensitive detection means is attached to the lower face of the support by said main plate.

In the human-machine interface according to the invention, a display device is placed on the opposite side of the support relative to the touch-sensitive detection means.

The support is secured to the housing by means of said lower face.

Finally, a haptic feedback means is provided for the purpose of applying a force to the touch-sensitive detection means in reaction to a detection carried out by the touch-sensitive detection means.

A principal advantage according to the invention lies in the removal of any extra thickness thus providing an aspect that is smooth, uniform and even to the interface. The appearance of the latter is thereby markedly improved.

Another advantage is one relating to logistics. Specifically, attaching the touch-sensitive detection means to a support before assembling the human-machine interface makes it possible to form a subassembly that can be manufactured more easily, for example in a location other than the assembly line for the human-machine interface.

It is understood here that the support makes it possible to concentrate all the tricky operations of assembly of the touch-sensitive detection means and of the decorative elements on the surface of the support.

Another advantage of the invention lies in the fact that the support provides a particularly flat surface which makes it easier to attach decorative film for example.

Other features, details and advantages of the invention will emerge more clearly on reading the description given below as an indication with respect to drawings in which:

FIG. 1 is a sectional view of a device according to the prior art,

FIG. 2 is a view from above of the device of FIG. 1,

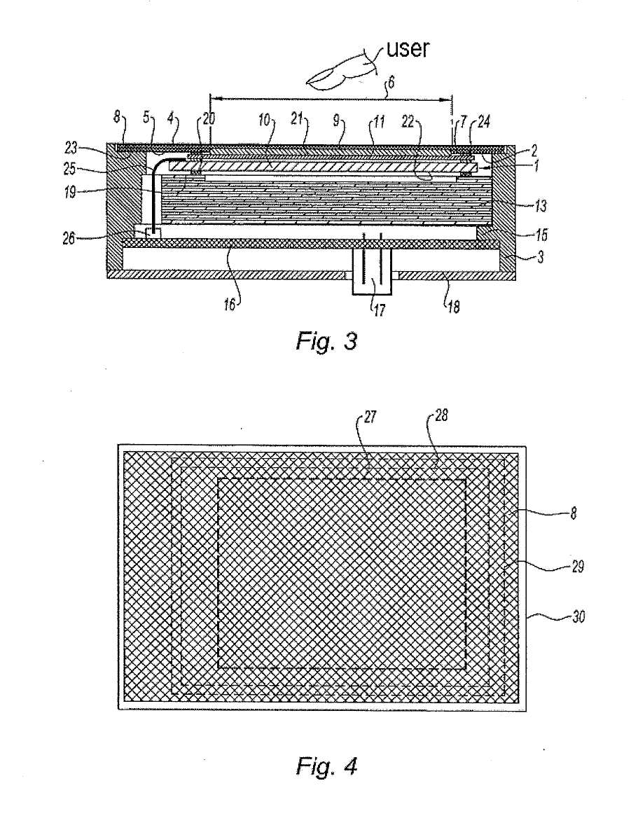

FIG. 3 is a sectional view of the interface according to the invention,

FIG. 4 is a view from above of the subject of FIG. 3,

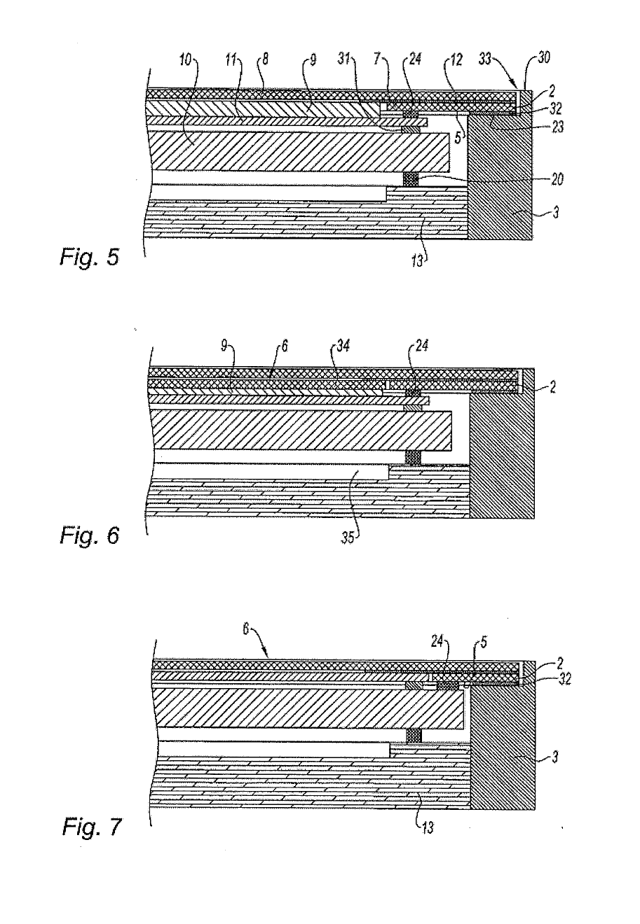

FIG. 5 is a sectional view showing details of the invention,

FIG. 6 is a sectional view of a first variant of the invention,

FIG. 7 is a sectional view of a second variant of the invention,

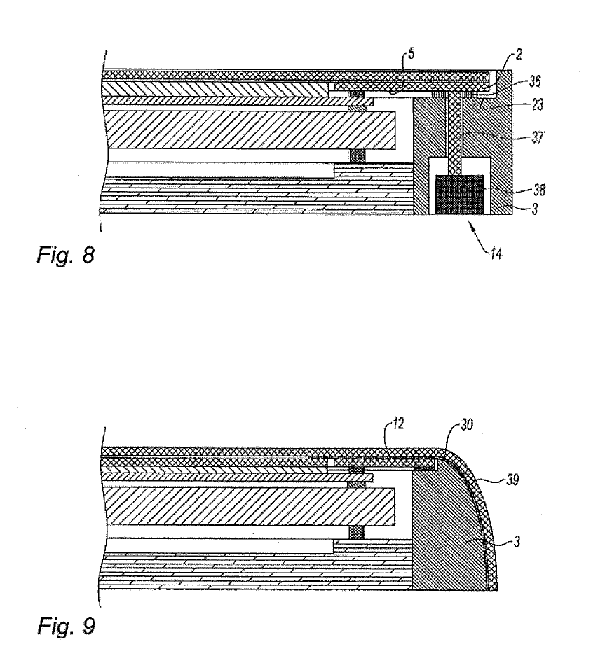

FIG. 8 is a sectional view of an enhancement of the invention,

FIG. 9 is a sectional view of an alternative of the invention.

It should be noted that the figures depict the invention in a detailed manner; said figures may naturally serve to better define the invention if appropriate.

FIG. 3 illustrates a human-machine interface according to the invention seen in section. A housing 3 comprises an internal recess inside which elements forming the interface are installed. A display device 13 is installed in the housing resting against a shoulder 15 made in the recess of the latter. The technology used by the display device is for example a backlit screen, an LCD screen, a plasma screen and in general any multifunctional screen, that is to say displaying a multiplicity of items of information such as navigation, the audio system, the temperature management of the vehicle interior for example. On the other side of the shoulder 15 a printed circuit or electronic circuit board 16 is installed on which an electric connector 17 is placed for the purpose of connecting the human-machine interface to the network of the motor vehicle. A cover 18 closes off the rear portion of the housing 3, said cover 18 comprising a hole for the connector 17 to pass through. It will be noted that this cover is placed on the rear face of the human-machine interface, that is to say providing access to the technical portion of the interface. Placed on the opposite side is the portion oriented toward the user, that is to say the portion that faces the user and that looks out into the interior of the motor vehicle.

The display device 13 is covered by the touch-sensitive detection means 1, the latter being distinct from the display means 13. An air and water seal is made between the display device 13 and the touch-sensitive detection means, more particularly the face of the display device 19 oriented toward the user and the rear face of the touch-sensitive detection means. This seal is achieved by a seal 20 placed on the periphery of the face 19 of the display device 13 oriented toward the user.

The touch-sensitive detection means 1 consists of a resistive sensor or a capacitive sensor, the invention finding a very particular application with a sensor of the resistive type. Said sensor consists of a main plate 10 and a secondary plate 11. These two plates are made of glass, the secondary plate 11 being thinner than the main plate 10. The secondary plate has the function of deforming under a force exerted by the finger of the user while the main plate is less deformable; its thickness is such that it does not flex under the effect of a pressure applied by the finger of a user. The sensor is thus capable of detecting the position of the finger of the user by virtue of a network of conductors placed between the main plate and the secondary plate, in an arrangement that is for example horizontal and vertical. The touch-sensitive detection means 1 is electrically connected to the electronic circuit board 16 by means of a multiconductor cable 25, the latter being connected to the electronic circuit board via a removable electric connector 26.

The touch-sensitive detection means 1 therefore has a sensitive face 21 oriented toward the user and a rear face 22 turned toward the display device 13. The touch-sensitive detection means 1 is attached to a support 2 which takes the form of a flat and rigid element with a thickness of between 0.20 and 0.50 mm. This element is a thin metal plate made for example of stainless steel. “Rigid” means that the thickness of this plate is such that it does not flex under the effect of the force exerted by the finger of a user in normal conditions of use of the human-machine interface. It is understood here that the support 2 is distinct from the housing 3 which surrounds the human-machine interface according to the invention.

The support 2 comprises two large faces called the upper face 4 and the lower face 5. The upper face 4 is that which faces the user and which is accessible to the touch of the latter. The lower face 5 is a face that is substantially parallel to the sensitive face 21 of the touch-sensitive detection means 1, the lower face 5 being turned toward the touch-sensitive detection means 1. In general, the upper face 4 is that which faces the interior of the vehicle while the lower face 5 is that which is oriented toward the inside of the instrument panel.

The housing 3 comprises a shoulder 23 that receives the support 2. This shoulder 23 delimits a cavity of which the length and width correspond substantially to the length and width of the support 2.

The touch-sensitive detection means 1 is attached to the inner face 5 of the support 2. This involves any means that can be used to secure two parts. Advantageously, a bead or drops of adhesive 24 make the mechanical connection between the sensitive face 21 of the touch-sensitive detection means and the lower face 5 of the support. Alternatively, the drops of adhesive may be replaced or supplemented by an adhesive strip. This arrangement makes it possible to obtain a touch-sensitive detection means assembled in “suspended” fashion in the human-machine interface.

The support 2 has an opening 6 delimited by an edge 7. When the opening 6 is made in the central portion of the support 2, the edge 7 peripherally surrounds the opening 6. This edge 7 covers the peripheral outer edge of the touch-sensitive detection means. The space created by the opening 6 in the touch-sensitive detection means 1 is filled by a filling element 9 the objective of which is to define in combination with the edge 7 and the upper face 4 of the support a flat and smooth surface. The filling element is a transparent and flexible film manufactured from a polycarbonate or polyethylene terephthalate (PET) strip.

A film 8 is placed on the upper face 4 of the support 2 so as to cover the opening 6 and the edge 7. This film extends over the whole surface of the support 2, and so it is understood that the dimensions of the film 8 and the dimensions of the support 2 are similar or even identical. Since this film covers the opening 6, it rests on the filling element 9 thus forming a surface that is totally smooth and uniform to the touch for the user. In this variant of the invention, the depth of the shoulder 23 is equal to the total of the

The film 8 is a transparent film which may have a single property or a combination of properties. A first property is associated with the decorative character of this facing film. Specifically, it is then easy to define a particular shape that can be seen by the user. The film 8 may also comprise antiscratch properties so as to prevent the appearance of any scratch marks on the surface of the human-machine machine. The film may also have an antireflective and diffusing property, the latter giving a matt appearance to the human-machine interface and preventing the mirror effects that are annoying for the user. The antireflective property prevents the incident light from rebounding from the surface. It involves a thin-layer treatment. The film may also have diffusion properties obtained by a slight lubrication which breaks up the incident light, reflecting it in all directions. Finally, the film 8 may have polarizing properties, that is properties that are capable of barring the light reflected by the glass plates of the touch-sensitive detection means in a given direction.

FIG. 4 shows the esthetic rendering of the invention. The inner dashed lines 27 illustrate the display limit of the screen 13 while the intermediate dashed lines 28 show the outer edge of the touch-sensitive detection means 1. The outer dashed lines 29 show the outer edge of the housing between the shoulder 23 and the inner cavity of said housing 3. An external edge 30 illustrates a peripheral band of the housing that can be seen by the user and that extends in one and the same plane as the film 8. A thickened black line materializes the peripheral clearance that exists between on the one hand the support 2 and the film 8 and on the other hand the housing 3 at its external edge 30. It is clearly visible in this figure that the film 8 and the support 2 extend up to the external edge 30 thus creating a smooth and even surface of a greater size than that available in the prior art.

FIG. 5 shows in detail the stacking of the elements forming the invention. As already mentioned, the display device 13 is mounted in the housing 3, a seal 20 is interposed between the display device 13 and the main plate 10. The latter is bonded to the secondary play 11 by an adhesive 31.

The touch-sensitive detection means 1 is bonded to the lower face 5 of the support 2, the latter being secured to the housing 3 in line with the shoulder 23 by an adhesive strip 32, notably a strip of adhesive or other attachment means. This makes it possible to ensure the positioning of the support 2 in the shoulder 23 of the housing 3 and thus keep the peripheral clearance 33 uniform and even between the film 8, the support 2 and the external edge 30 of the housing.

The filling element 9 comes in line with the opening 6 in order to fill the latter. The thickness of this filling element is in this instance equal to the total of the thickness of the drop of adhesive 24 and the thickness of the support 2.

A masking layer 12 is preferably applied to the film 8 or to the upper face 4 of the support 2. It, will be noted that this masking layer is opaque and overflows from the edge 7 to the filling element 9. This masking layer 12 has the function of hiding the technical and peripheral portions of the touch-sensitive detection means 1, in particular the drops of adhesive 24. Finally, this layer is screen printed onto the film 8 before it is applied to the support 2.

FIG. 6 shows a first variant of the invention in detail. The difference in relation to FIG. 5 lies in the use of an additional film 34 installed on the filling element 9. The thickness of the latter is in this instance limited to the thickness of the drops of adhesive 24 placed between the touch-sensitive detection means 1 and the support 2. The opening 6 is then filled with the additional film 34 and its thickness is similar to the thickness of the support 2. A masking layer 12 is placed on the support 2 and straddling the surround of the additional film 34. Finally, the film 8 covers the whole assembly in order to give the esthetic appearance that is sought. The advantage of this arrangement lies in the fact that the additional film 34 is a technical film, for example having polarizing properties while the film 8 has no polarizing property. Specifically, polarizing films are costly and it is therefore of particular value to limit the surface area of this film to the effective surface area, that is to say the surface area lit by the display device 13. This figure shows that the additional film 34 stops in line with a display zone 35 of the screen 13.

FIG. 7 shows a variant for attaching the touch-sensitive detection means 1 to the support 2. The latter has an opening 6 of which the dimensions are slightly greater than the dimensions of the secondary plate 11 of the touch-sensitive detection means 1. The edge 7 nevertheless covers the main plate 10 so that the adhesive or the drops of adhesive 24 are interposed between the face of the main plate 10 oriented toward the user and the lower face 5 of the support 2. It can be seen that the secondary plate 11 is included in the opening 6 of the support 2, the thickness of said plate being similar to the thickness of the support 2 and placed in the extension of the support. The adhesive strip 32 between the support 2 and the housing 3 is present, as is the masking layer 12. The advantage of such a solution for attachment between the touch-sensitive detection means and the support lies in the fact that the bonding is applied to the main plate 10 which has a thickness that resists forces better. It will be noted that this variant of the invention has no filling element 9 because the residual space resulting from the masking layer 12 is slight. This variant also has the advantage of being more compact in a direction perpendicular to the display device 13.

FIG. 8 shows a human-machine interface identical to that shown and explained in FIG. 5 with the exception of an enhancement. Touch-sensitive detection systems suffer from a lack of feel by users. This is why the invention incorporates a haptic feedback means 14 designed to apply a force to the touch-sensitive detection means 1 in reaction to a detection carried out by the touch-sensitive detection means 1. In this enhancement, the support 2 is not bonded to the housing 3. In contrast, a damper 36 is interposed between the lower face 5 of the support 2 and the housing 3 substantially on the shoulder 23. The damper 36 is flexible and it can be manufactured from an elastomer, a rubber or silicone. This damper 36 in this instance takes the form of a shim but it may also take the form of a bead that runs round the support. A connecting part 37 links the lower face 5 of the support 2 to at least one actuator 38 of which the function is to cause a physical sensation that the user will feel on activation by the touch-sensitive detection means of a button or of a particular function. This actuator may be an electromagnet with a plunger core, a vibrator with a “voice coil” (loudspeaker) electromagnet or any other means causing a haptic feel.

FIG. 9 shows an alternative of the invention. The attachment of the touch-sensitive detection means 1 to the support 2 is identical to that shown and explained in FIG. 6. The difference lies in the shape of the housing 3 which has a rounded edge 39. The film 8 which extends over the opening 6 and over the support 2 continues on the external edge 30 of the housing and on the edge 39. The masking layer 12 extends from the support 2, covers the external edge 30 and also continues over the edge 39 of the housing 3. In this solution, the film 8 can be preformed, that is to say having, before mounting, a shape that matches that of the support and of the housing. In this way the whole of the human-machine interface according to the invention is covered in a uniform manner which makes it possible to have a product of complex shape having a surface that is in continuity with the touch-sensitive surface on which the user acts.

1. A human-machine interface comprising:
a touch-sensitive detection means; and
a support configured to be mounted in a housing, said support comprising:
an upper face oriented toward a user of the human-machine interface,
a lower face opposite to the upper face, and
an opening, wherein the touch-sensitive detection means is attached to the lower face of said support.

2. The human-machine interface as claimed in claim 1, wherein the touch-sensitive detection means is bonded to the lower face of said support.

3. The human-machine interface as claimed in claim 1, wherein the opening is delimited by an edge of the support, the touch-sensitive detection means being attached to said edge.

4. The human-machine interface as claimed in claim 1, wherein the support is a flat and rigid element comprising a metal plate with a thickness of less than 0.5 mm.

5. The human-machine interface as claimed in claim 3, wherein the edge is peripheral all around the opening.

6. The human-machine interface as claimed in claim 3, wherein a film is placed on the upper face of the support so as to cover the opening and the edge.

7. The human-machine interface as claimed in claim 6, wherein the film is one selected from the group consisting of a film with decorative properties, a film with antiscratch properties, a film with antireflective properties, a film with diffusion properties, and a film with polarizing properties.

8. The human-machine interface as claimed in claim 6, wherein a filling element is placed between the touch-sensitive detection means and the film, said filling element being installed in line with the opening.

9. The human-machine interface as claimed in claim 8, wherein the filling element is a transparent film.

10. The human-machine interface as claimed in claim 6, wherein a masking layer is interposed between the upper face of the support and said film.

11. The human-machine interface as claimed in claim 6, wherein the film also covers the housing.

12. The human-machine interface as claimed in claim 1, wherein the touch-sensitive detection means is a resistive sensor, said sensor comprises a main plate and a secondary plate, said touch-sensitive detection means being attached to the lower face of the support by said secondary plate.

13. The human-machine interface as claimed in claim 1, wherein the touch-sensitive means is a resistive sensor, said sensor comprises a main plate and a secondary plate, said touch-sensitive detection means being attached to the lower face of the support by said main plate.

14. The human-machine interface as claimed in claim 1, wherein the touch-sensitive detection means is a capacitive sensor, said sensor comprises a plate or a film to which capacitors are attached, said touch-sensitive detection means being attached to the lower face of the support by said plate or film.

15. The human-machine interface as claimed in claim 1, wherein a display device is placed on the opposite side of the support relative to the touch-sensitive detection means.

16. The human-machine interface as claimed in claim 1, wherein the support is secured to the housing by said lower face.

17. The human-machine interface as claimed in claim 1, wherein a haptic feedback is provided for the purpose of applying a force to the touch-sensitive detection means in reaction to a detection carried out by the touch-sensitive detection means.

18. The human-machine interface as claimed in claim 17, wherein the force is applied to the touch-sensitive detection means by the support.
